(19) United States
(12) Patent Application Publication
(10) Pub. No.: US 2026/0320453 A1
(43) Pub. Date: Oct. 15, 2026

(54) SPINWAVE COHERENT ISING MACHINE

(71) Applicant: SPINWAVE COMPUTING AB, Sollentuna (SE)

(72) Inventors: Artem LITVINENKO, Göteborg (SE); Roman KHYMYN, Lindome (SE); Johan AKERMAN, Sollentuna (SE)

(73) Assignee: SPINWAVE COMPUTING AB, Sollentuna (SE)

(21) Appl. No.: 19/104,148

(22) PCT Filed: Aug. 19, 2023
(86) PCT No.: PCT/SE2023/050841

§ 371 Date: Feb. 14, 2025

(30) Foreign Application Priority Data
Aug. 19, 2022 (SE) 2250979-8
May 11, 2023 (SE) 2330212-8

(51) Int. Cl. G06N 7/01

(52) U.S. Cl. CPC G06N 7/01

(57) ABSTRACT

A spinwave Coherent Ising computational machine, SCIM, comprising: a ring circuit comprising: a spinwave delay line for propagating a plurality artificial Ising spinwave RF pulses, an electronic parametric phase-sensitive amplifier electrically connected to the spinwave delay line configured to cause phase degeneracy of the plurality of propagating artificial Ising spinwave RF pulses. The SCIM also comprises a measuring unit, interaction unit and an annealing and computing unit.

### FIELD OF THE INVENTION

The disclosed invention generally relates to non-von-Neuman computing architectures and more particularly to a combinatorial spinwave Ising-model solver using the physical annealing method.

### BACKGROUND OF THE INVENTION

The Ising Model (S. Kirkpatrick, C. D. Gelatt, M. P. Vecchi, Science 220, 671, 1983) is an efficient computational tool that can be used to solve a variety of difficult computational problems time- and hardware-efficiently by using its physical implementation—Ising machine. Ising model manifests that if there is a magnetic structure that is made of an array of magnetic domains and each domain is either up or down cᵢ, cⱼ: +1 or −1 magnetic spin and they are coupled to each other through a magnetic field with a coefficient Jᵢⱼ, one can calculate the energy of the whole system by simple summation of the product of each spin state in the pairs and their coupling:

$$E = - {\sum }_{i , j} {J}_{ij} {c}_{i} {c}_{j} \qquad ( 1 )$$

The Ising problem is to find for a given magnetic structure with particular coupling between elements, a unique configuration of spins (up or down) so that the whole magnetic structure has the lowest energy state. The Ising problems belong to the category of so-called NP-hard computational problems (F. Barahona, Journal of Physics A: Mathematical and General 15, 3241, 1982). The term hard means that this problem is representative of the whole class of NP and can be mapped to an Ising machine and then solved with polynomial time.

An Ising machine can be implemented with a physical system that is made of an array of elements where each element has two well-defined and stable states that can be either +1 or −1 to represent an Ising spin and where each element can be connected to any other with a variable continuous coefficient. By setting different coefficients one can program this machine to solve a particular Ising problem. An Ising machine when turned on tends to go into the lowest energy state by flipping the states of individual spins. The final configuration of the spins coincides with the ground state of the Ising problem and represents its solution.

To date, Ising machines have been implemented with many physical paradigms, including quantum annealing (Johnson, M., Amin, M., Gildert, S. et al. Quantum annealing with manufactured spins. Nature 473, 194-198, 2011 & Davide Venturelli, Salvatore Mandrà, Sergey Knysh, Bryan O'Gorman, Rupak Biswas, and Vadim Smelyanskiy. Phys. Rev. X 5, 031040-Published 18 Sep. 2015), optical parametric oscillators (McMahon, Peter L., Alireza Marandi, Yoshitaka Haribara, Ryan Hamerly, Carsten Langrock, Shuhei Tamate, Takahiro Inagaki et a″. “A fully programmable 100-spin coherent Ising machine with all-to-all connections.” Science 354, no. 6312, 2016:614-617 & Inagaki, Takahiro, Yoshitaka Haribara, Koji Igarashi, Tomohiro Sonobe, Shuhei Tamate, Toshimori Honjo, Alireza Marandi et a″. “A coherent Ising machine for 2000-node optimization proble” s.” Science 354, no. 6312, 2016:603-606 & Honjo, Toshimori, Tomohiro Sonobe, Kensuke Inaba, Takahiro Inagaki, Takuya Ikuta, Yasuhiro Yamada, Takushi Kazama et a″. “100,000-spin coherent Ising machi″e.” Science advances 7, no. 40, 2021), phase transition nano-oscillators (Dutta, S., A. Khanna, J. Gomez, K. Ni, Z. Toroczkai, and S. Datt “. “Experimental demonstration of phase transition nano-oscillator based Ising machine.” In 2019 IEEE International Electron Devices Meeting IEDM, pp. 37-8. IEEE, 2019), stochastic nanomagnets (Sutton, Brian, Kerem Yunus Camsari, Behtash Behin-Aein, and Supriyo Datt “. “Intrinsic optimization using stochastic nanomagne” s.” Scientific reports 7, no. 1, 2017:1-9), electronic CMOS SRAM (M. Yamaoka, C. Yoshimura, M. Hayashi, T. Okuyama, H. Aoki and H. Mizun “, “A 20 k-Spin Ising Chip to Solve Combinatorial Optimization Problems With CMOS Annealing,” in IEEE Journal of Solid-State Circuits, vol. 51, no. 1, pp. 303-309, January 2016, doi: 10.1109/JSSC.2015.2498601), electronic LC oscillators. (Tianshi Wang, Leon Wu, and Jaijeet Roychowdhury. 2019. New Computational Results and Hardware Prototypes for Oscillator-based Ising Machines. In Proceedings of the 56th Annual Design Automation Conference 2019. Association for Computing Machinery, New York, NY, USA, Article 239, 1-2. & Wang, Tianshi and Jaijeet S. Roychowdhury. “OIM: Oscillator-based Ising Machines for Solving Combinatorial Optimisation Problems.” UCNC, 2019), and spin-Hall nano-oscillators (Albertsson, Dagur Ingi, Mohammad Zahedinejad, Afshin Houshang, Roman Khymyn, Johan Åkerman, and Ana Rus “. “Ultrafast Ising Machines using spin torque nano-oscillato” s.” Applied Physics Letters 118, no. 11, 2021 &. McGoldrick, Brooke C., Jonathan Z. Sun, and Luqiao Li “. “Ising machine based on electrically coupled spin Hall nano-oscillato” s.” Physical Review Applied 17, no. 1, 2022). All the concepts are characterized by different speeds, power consumption, number of supported spins, physical dimension, etc. but can still be divided into two distinct groups—spatially distributed oscillator arrays and time-multiplexed soliton systems as shown in FIGS. 1A and 1B.

The most important parameters for Ising Machines are the time to solution and the number of supported spins, and these parameters are strongly interconnected. In FIG. 1C we present time to solution as a function of annealing time and problem size N. For Ising Machines based on physical arrays of oscillators the main problem is interconnectivity because as the number of oscillators N grows the number of intersections between coupling lines increases dramatically as −O(N²). This problem is solved by grouping the elements with a sparse connection into a so-called chimera graph. However, it trades off the computational time-to-solution which in the case of the chimera graph connection scheme increases as −O(N²) (FIG. 1C). It is the same growth rate as the computation speed of classical computers based on a von-Neuman architecture which means that there is no principal computational advantage in using Ising Machines built with spatially distributed oscillators.

For Coherent Ising Machines based on propagating light pulses the interconnectivity for a problem of all-to-all connected spins is easily solved with the time-multiplexing method. Computational problems with all-to-all connected spins are characterized by the computational time that grows as −O(N) when solved on physical Ising Machines. Therefore, the time multiplexing method makes computational time to solution for Ising problems with a large (>50) number of spins reasonable. The first time-multiplexing Ising Machine was implemented with optical parametric oscillators (OPOs) that are in the form of propagating light pulses in optical waveguides. The interconnectivity is implemented electrically (FIG. 1B) by consecutive measurements of each propagating light pulses-OPOs and then adding to the additional small (r<<1) contributions according to the coefficients in Ising problem:

$${f}_{i} = r {\sum }_{j} {J}_{ij} {c}_{j} \qquad ( 2 )$$

$${J}_{ij} = \{ \begin{matrix}{J}_{11} & ⋯ & {J}_{1 j} \\ ⋮ & ⋱ & ⋮ \\ {J}_{i 1} & ⋯ & {J}_{ij}\end{matrix} \} \qquad ( 3 )$$

For the moment, time-multiplexed CIMs seem to be the most promising Ising Machine configuration for combinatorial problems with large (>50 number of elements) due to −O(N) computational speed. Even SHNO-based Ising Machines that are projected to provide unpresidential computational speed starting from tens of nanoseconds cannot compete with Coherent Ising Machines for a graph size above 50 as they belong to −O(N²) class of IM. The number of supported elements in Ising problems solved by optical CIMs was progressively growing from 100 (McMahon, Peter L et al. 2016) spins through 2000 (Inagaki, Takahiro et al. 2016) and recently a CIM supporting 100000 spins was reported (Honjo, Toshimori et al. 2021). However, despite clear progress in the number of supported spins, current CIMs are still not in the market as they have a considerable disadvantage of size, large power consumption, and, most importantly, costly optical infrastructure requiring optical tables, precise positioners, etc.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a spinwave Coherent Ising computational machine, SCIM, comprising: a ring circuit comprising: a spinwave delay line for propagating a plurality artificial Ising spinwave RF pulses, an electronic parametric phase-sensitive amplifier electrically connected to the spinwave delay line configured to cause phase degeneracy of the plurality of propagating artificial Ising spinwave RF pulses. A measuring unit in connection with the ring circuit, the measuring unit configured to measure the phase of each of the plurality of artificial Ising spinwave RF pulses. An interaction unit for implementing the magnitude and phase of the interactions corresponding to the artificial spinwave RF pulses. The SCIM comprising an annealing and computing unit configured to perform annealing of the plurality of artificial Ising spinwave RF pulses and perform statistical analysis on the plurality of steady-state solutions of the Ising machine.

This disclosure relates to a novel architecture of Coherent Ising Machines (CIM) for solving combinatorial optimization problems. The key element of Spinwave CIM (SCIM) is a YIG spinwave delay line that is used as a waveguide where spinwave RF pulses propagate and are stored. The advantage of spinwave devices is the exceptionally slow group velocity of propagating spinwaves that is several orders lower than the speed of light. It allows miniaturizing of the CIM waveguide size down to the mm scale while keeping a high number of supported spins. Another advantage of the proposed invention in contrast to optical CIMs is that spinwaves can also be easily excited by and transduced back to electrical RF signals, which allows performing the compensation of propagation losses via low-power and power-efficient RF phase-sensitive and linear amplifiers. The transformation between spinwave RF pulses to electric RF pulses and back is implemented with wideband thin-wire transducers. The rapid measurement of RF circulating pulses is done electrically via homodyne IQ-demodulator and CORDIC algorithm implemented in microcontroller or FPGA that allows independent deduction of the phase and the amplitude of the RF pulses within pulse circulation time.

An Ising model computational method is also provided.

Further advantageous embodiments are disclosed in the appended and dependent patent claims.

### BRIEF DESCRIPTION OF THE DRAWINGS

These and other aspects, features and advantages of which the invention is capable will be apparent and elucidated from the following description of embodiments of the present invention, reference being made to the accompanying drawings, in which

FIG. 1A. is a spatially distributed oscillator array Ising Machine.

FIG. 1B is a time-multiplexed Ising Machine.

FIG. 1C is a graph showing time to solution as a function of annealing time and problem size N, showing a comparison between existing solutions to the present disclosure, which is shown as the dashed line labelled Coherent Ising Machine Spinwaves GU.

FIG. 2A is a block diagram of a Spinwave Coherent Ising Machine comprising microwave delay lines and a microcontroller according to an aspect. The block diagram shows interconnections and interactions between elements of the SCIM.

FIG. 2B is a block diagram of a Spinwave Coherent Ising Machine comprising an FPGA according to an aspect. The block diagram shows interconnections and interactions between elements of the SCIM.

FIG. 3A shows the S₂₁-parameter of a YIG spinwave delay line.

FIG. 3B shows the delay time of the YIG spinwave delay line.

FIG. 4 shows the amplification of the phase-sensitive amplification block as a function of phase difference between circulating RF pulses and a reference signal.

FIG. 5 shows time traces of circulating RF pulses, their instantaneous phase and a control signal for RF switches.

FIG. 6 is a schematic of the transition between a non-optimal initial state and an optimal solution for MAX-CUT4 problem computed with the SCIM after 12 circulations.

FIG. 7A shows time traces of the circulating RF pulses and their instantaneous phase for the 1^{st} circulation period.

FIG. 7B shows time traces of the circulating RF pulses and their instantaneous phase for an optimal solution computed at the 12^{th} circulation period.

FIG. 8 shows the evolution of time traces and instantaneous phase for the 3^{rd} RF pulse within intermediate circulation steps at top and middle panel, correspondingly. Bottom panel shows the evolution of the instantaneous phase at the center of 1^{st}, 2^{nd}, 3^{rd} and 4^{th} RF pulse withing intermediate circulation steps.

FIG. 9A shows SCIM time traces for the measurement of time-to-saturation and time-to-solution parameters. Top panel: a control signal for the linear amplifier. Middle panel: an amplified signal of RF propagating pulses. Bottom panel: phase values in the centre of each propagating RF pulse sampled at each circulation period. The linear amplifier switches down at moment 1 μs with blackout period of 2 μs to ensure signal suppression.

FIG. 9B shows circulation number and time-to-solution parameters for a 4-spin MAX-CUT problem as a function of the coupling strength.

FIG. 10 shows a SCIM comprising a plurality of ring circuits, each ring circuit connected to an FPGA.

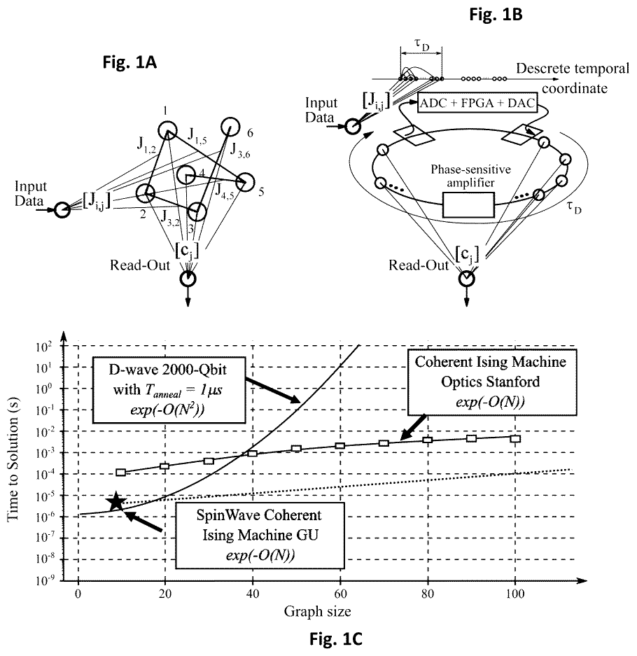

### DETAILED DESCRIPTION

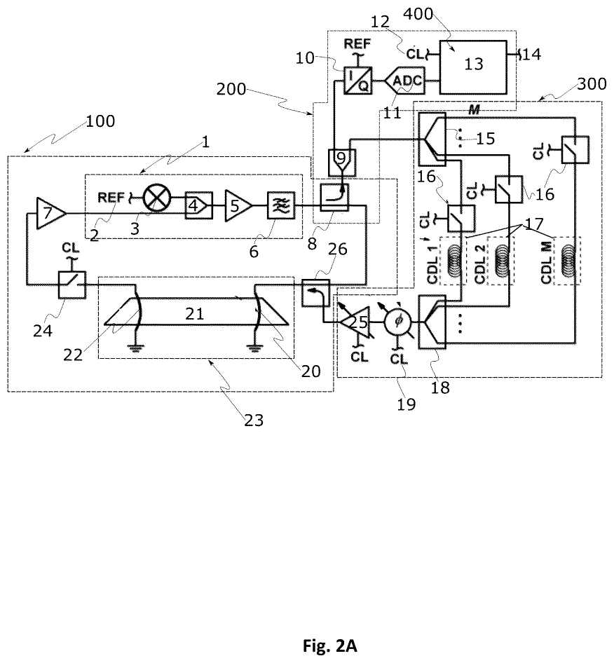

FIGS. 2A and 2B show a spinwave coherent Ising machine (SCIM). The SCIM comprises an electronic part 100, 200, 300, 400 and a physical spinwave waveguide 21, 23. The electronic part is for linear and parametric amplification of RF pulses, RF pulse interconnection, and RF pulse measurement. The SCIM comprises a ring circuit 100 which comprises at least the physical spinwave waveguide 21, 23, a phase-sensitive amplifier block 1, and the necessary electrical components for connecting the ring circuit 100 to the electronic part 200, 300, 400 of the SCIM. The physical spinwave waveguide 21, 23 is for the excitation of spinwave RF pulses, propagation of spinwave RF pulses and transformation of spinwave RF pulses to microwave RF pulses. The artificial spin states are implemented via the phase of the spinwave RF pulses propagating in the spinwave delay line 21, 23.

The SCIM comprises a spinwave delay line 21, 23 that supports up to N Ising spins in the form of propagating spinwave RF pulses. The spinwave delay line consists of a ferromagnetic material, such as Yttrium iron garnet, YIG, spinwave waveguide 21 with an input 20 and an output 22 electromagnetic-spinwave transducers. The spinwave delay line 21 is generally a thin film. The spinwave delay line 21 may have a thickness of from 0.1 to 100 μm, such as about 5 μm. The spinwave delay line 21 may be a thin film YIG waveguide provided to a bulk Gadolinium Gallium Garnet, GGG substrate. The input transducer 20 converts electromagnetic, microwave RF pulses, to spinwaves which propagate along the length of the spinwave waveguide 21. The output transducer 22 converts the spinwaves propagating in the spinwave waveguide 21 to electromagnetic, microwave RF pulses. The length of the spinwave delay line 21 is selected depending on the material and patterning of the waveguide 21 and the number of spins required by the SCIM. A spinwave waveguide of only 7 mm has been found to host up to 11 spins thanks to the exceptionally slow spinwave propagation speed in the present system. However, different lengths are envisioned by using slower spinwave modes and patterned YIG waveguides.

The SCIM employs a time-multiplexing approach similar to optical CIMs but in the microwave frequency domain, which leads to performance improvements.

In contrast to optical CIMs where pulses propagate and are amplified in an optical ring system, never leaving the ring, the SCIM is a multi-physical system where amplification of the propagating pulses and their signal processing is performed outside of the delay line 21, 23 in the power efficient electronic part. This is enabled as the carrier frequency of the propagating spinwaves is around 3 GHz and therefore can easily be handled by inexpensive and commercially available RF components.

In the SCIM the ring also known as the loop comprises the physical spinwave waveguide 21, the input and output transducers 20, 22, and components of the electrical system such as the linear and parametric phase-sensitive amplifier, couplers and switches.

The spinwave excitation frequency depends on the strength and orientation of the static magnetic field applied to the thin film delay line and the magnetic properties of the thin film material, such as the saturation magnetisation (Mₛ), the exchange stiffness (A), and the gyromagnetic ratio (γ). In the SCIM the static magnetic field is applied at an angle of θ=53° with respect to the film plane, with its in-plane component parallel to the antennas, i.e., perpendicular to the spinwave propagation along the waveguide. In this configuration the propagating waves are of a mixed type between magnetostatic surface spin waves (MSSW) and forward volume spin waves (FVMSW). Via empirical testing a value of the internal field of H=0.04T, and an out of plane angle of θ=53° were found to be motivated by high excitation efficiency and low total losses in the YIG delay line when using thin copper wire input and output transducers 20, 22. Additionally, in this configuration spinwaves are unidirectional and will be excited most efficiently in only one direction, which prohibits multi-transit spinwave echo signals, and therefore improves the frequency stability of the SCIM.

The SCIM can be considered as a ring oscillator circuit. According to circuit design theory, a circuit oscillates when the Barkhausen stability criteria are satisfied, that is β·A=1 and <β·A=2π·n (where n=0, 1, 2 . . . ), where A is the total amplification in the ring, B is the total loss, and <β·A is the phase accumulated in the loop. The Barkhausen criteria of the ring circuit 100 are narrowed by the phase sensitive amplifier block 1. The operating frequency f₀ of SCIM is set by parametric phase-sensitive amplification block 1 via a reference frequency signal f_{ref}=f₀ 2. The parametric phase-sensitive amplifier limits stable oscillations only at either phase 0 or π relative to the reference frequency signal, consequently binarizing the system. The parametric phase-sensitive amplifier also induces second-harmonic frequency locking to the external reference signal which further improves frequency stability.

The spinwave waveguide 21, 23 and the parametric phase-sensitive amplification block 1 form the key components of the ring circuit 100.

The losses in YIG spinwave waveguide are compensated by the phase-sensitive block 1 and a linear amplifier 7. The phase of each circulating RF pulse cⱼ is measured by a measurement unit 200. The measurement unit 200 comprises a programmable module 13, 210 implementing the CORDIC algorithm. The measurement unit 200 may comprise a directional RF coupler 8, a power divider 9, an IQ-demodulator 10, an analogue to digital converter 11. In detail, the phase of each circulating RF pulse c is measured by deflecting 10% of power after a filter 6 with a directional coupler 8, power divider 9 and measuring the phase with an IQ-demodulator 10, 2-channel ADC 11, and a CORDIC algorithm implemented in programmable module 13, 210 as shown in FIG. 2A. In the systems of both FIGS. 2A and 2B the CORDIC algorithm is implemented in a programmable module 13, 210, that is the CORDIC algorithm is implemented by either a microcontroller 13 as shown in FIG. 2A, or a field programmable gate array, FPGA 210 in connection with a microcontroller 210 as shown in FIG. 2B.

The phase-binarized oscillation conditions are valid for continuous oscillations in the loop. In order to define separate time-multiplexed and phase-binarized artificial Ising spins an RF switch 24 is triggered by a square wave signal with a variable frequency to control the spinwave RF pulse length. The frequency of the switching is determined by the total delay in the ring and the required number of supported artificial spins. The RF switch 24 also prevents propagating spinwave RF pulses from spreading due to spinwave dispersion and non-constant delay time over the occupied frequency range.

The SCIM comprises an interaction unit 300 for implementing the magnitude and phase of the interactions corresponding to the pseudo spin pulses. As described below the interaction unit 300 may be implemented by cable delay lines 17, or the programmable module 13, 210 such as a field programmable gate array, FPGA 210 in connection with the microcontroller 13.

If the interaction unit 300 comprises cable delay lines 17 as shown in FIG. 2a, then the interaction unit 300 additionally comprises an RF switch 16 connected to each cable delay line 17, a multichannel RF combiner 18, a digital phase shifter 19, digital variable amplifier 25 and RF coupler 26. The RF coupler 26 connects the interaction unit 300 to the ring circuit 100.

The SCIM comprises an annealing and computing unit 400 which performs annealing by restarting the circulation of plurality of artificial Ising spin pulses and performs statistical analysis on the plurality of steady-state solutions. The annealing and computing unit 400 comprises the microcontroller 13 and, when present, the FPGA 210. The microcontroller 13, and the FPGA 210 may therefore be considered to be components of both the interaction unit 300 and the annealing and computing unit 400. In general, throughout the SCIM electronic components may have multiple functions and may form aspects of the measurement unit 200, interaction unit 300, and annealing and computing unit 400 at different instants during propagating of artificial spinwave pulses.

In the SCIM of FIG. 2A, cable delay lines 17 delay each circulating RF pulse by multiple of pulse repetition time introducing the coupling between Ising spins. The microcontroller 13 performs the computation of the Ising matrix (Equation 2,3) and sets the coupling between each Ising spin by controlling RF switches 16 in every delay channel, a phase shifter 19 and a variable amplifier 25 which change the phase and amplitude of additional coupling RF pulses. Coupling RF pulses after a variable amplifier 25 are added to the circulating RF pulses via power coupler 21. The microcontroller 13 controls RF switches via control lines 12, performs an annealing procedure, and communicates with external systems via data port 14.

As shown in the SCIM in FIG. 2B, the CORDIC algorithm may be implemented in an FPGA 210. In such an architecture, the FPGA 210 also performs the computation of the Ising matrix and sets the coupling between each Ising spin by controlling phase shifter 19 and variable amplifier 25 which change the phase and the amplitude of additional coupling RF pulses that are formed by the RF switch 16. Coupling RF pulses after a variable amplifier 25 are added to the circulating RF pulses via RF power coupler 26. In the configuration shown in FIG. 2B cable delay lines 17 shown in FIG. 2A are not used to implement the CORDIC algorithm, and are therefore not present in the SCIM system.

As shown in FIG. 2B, the SCIM comprising an FPGA 210 comprises a microcontroller 13. The microcontroller 13 controls the FPGA 210, clock frequencies to the ADC 11, performs an annealing procedure, and optionally communicates with external systems 14.

The number N of supported spins is proportional to the total delay time τ_{delay} in a spinwave delay line and inversely proportional to the minimum possible spinwave RF pulse width τₚ:

$$N = \frac{{τ}_{delay}}{{τ}_{p}} \qquad ( 4 )$$

The minimum possible spinwave RF pulse duration is limited by the largest value derived from the 3-dB bandwidth BW_{sw} of the spinwave spectra and the delay time deviation Δτ_{delay} within BW_{sw}.

$${τ}_{p} \geq \{ \begin{matrix}\frac{1}{{BW}_{sw}} , \\ Δ {τ}_{delay}\end{matrix} \qquad ( 5 )$$

A particular Ising matrix (Equation 3) can be mapped into a Spinwave Coherent Ising Machine by setting an arbitrary time domain pattern of control signal for RF switches 16 so that each RF propagating pulse can be connected to any other RF pulses. In an architecture comprising cable delay lines, the number of cable delay channels should be M=N−1 to support all-to-all connections. The delay time in cable delay lines CDL1 17 to CDL M 17 is proportional to their index:

$${τ}_{CDL m} = \frac{m}{{f}_{pulses}} \qquad ( 6 )$$

where fₚᵤₗₛₑₛ is a pulse repetition frequency.

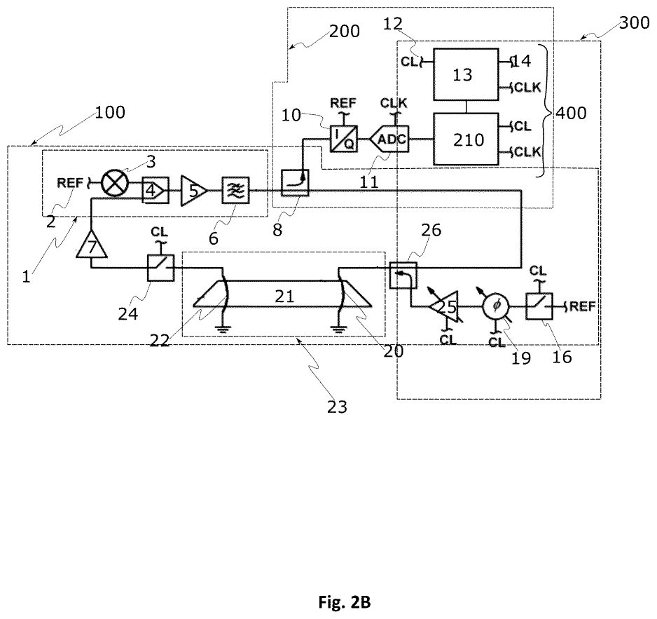

FIG. 3A shows the spinwave spectra of the YIG spinwave delay line in the form of S₂₁-parameter. The bandwidth of the spinwave generation spectrum is 60 MHz measured at −3 dB level. FIG. 3B shows the delay time of the YIG spinwave delay line [23]. The mean delay time τ_{delay} is 270.62 ns. The limit of minimal pulse duration derived from bandwidth is 16.75 ns while the delay time deviation imposes a stronger limitation of 30.19 ns that results in 8 supported Ising spins, rounded down from 8.9.

Phase sensitivity is achieved by doubling the reference signal frequency via a frequency doubler 3 and combining it with an RF signal converted from spinwave RF pulses. The amplitude of the total signal after power divider/coupler 4 is set at a level that is close to the saturation point of an RF amplifier 5. The amplitudes of the signals at two inputs of a power divider/coupler 4 which have a relative phase close to 0° or 180° are added and the total signal amplification is affected by the saturation of the amplifier 5 more than if signals have a phase difference is close to 90° or 360°. The signal after an amplifier 5 is filtered by a highpass filter 6 with a cut of frequency f₀ to remove 2f₀ signal after phase-sensitive amplification.

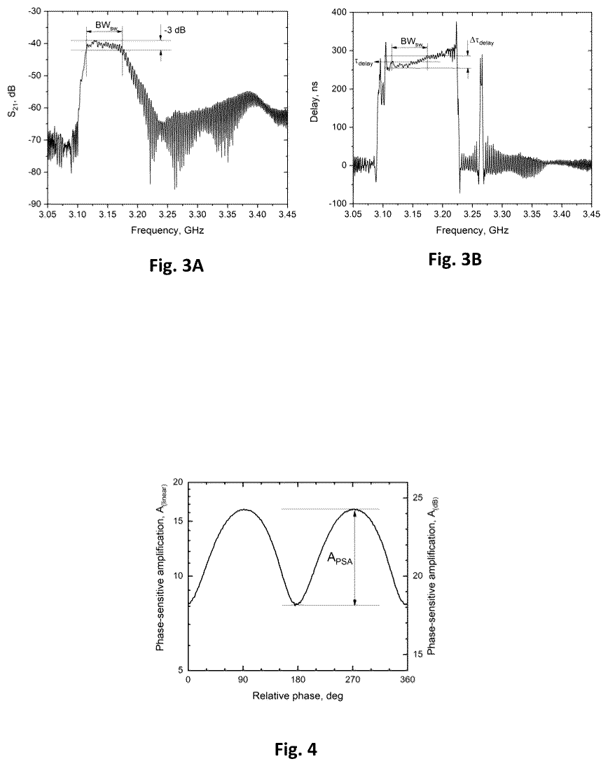

FIG. 4 shows the amplification of the phase-sensitive amplification block 1 as a function of a phase difference between the circulating RF pulses and the reference signal 2. The difference in amplification is denoted as A_{PSA}, which equals 6 dB and represents the phase sensitivity of the block. The value of phase sensitivity can be adjusted by changing the amplitude of the reference signal at the input of the frequency multiplier.

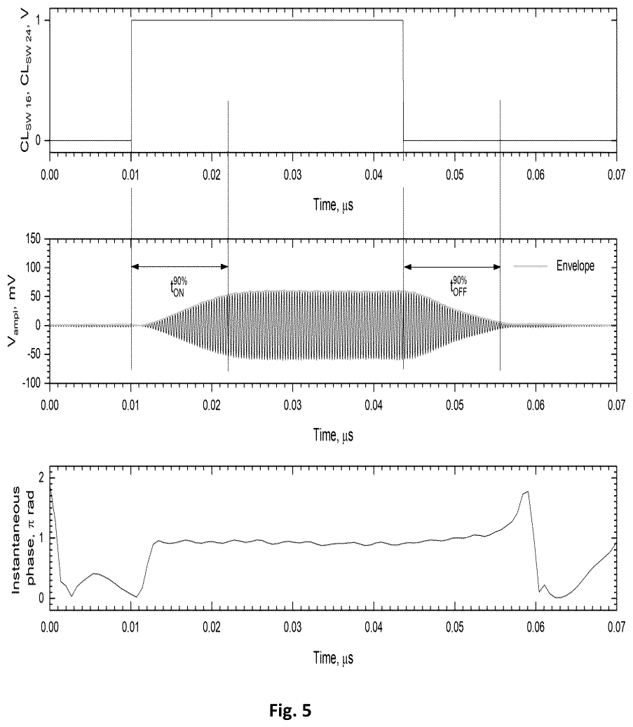

FIG. 5 shows time traces of control signal for RF switches, RF signal after RF amplifier 7, and instantaneous phase that is calculated from RF signal Vₐₘₚₗ. RF switch 26 is used to counteract the spreading of propagating RF pulses due to the delay time deviation Δτ_{delay} of the YIG spinwave waveguide.

$${t}_{ON}^{90 \%}$$

is the switching time from the rising front of control signal CL_{SW} 26 to the moment when RF switch 16 is open for 90%. Similarly,

$${t}_{OFF}^{10 \%}$$

is the switching time from CL_{SW} 26 falling front to the moment when RF switch 16 is open for 10%. RF switch 16 is used to form coupling RF pulses that are added to the circulating RF pulses and has similar parameters

$${t}_{ON}^{90 \%}$$

and

$${t}_{OFF}^{10 \%} .$$

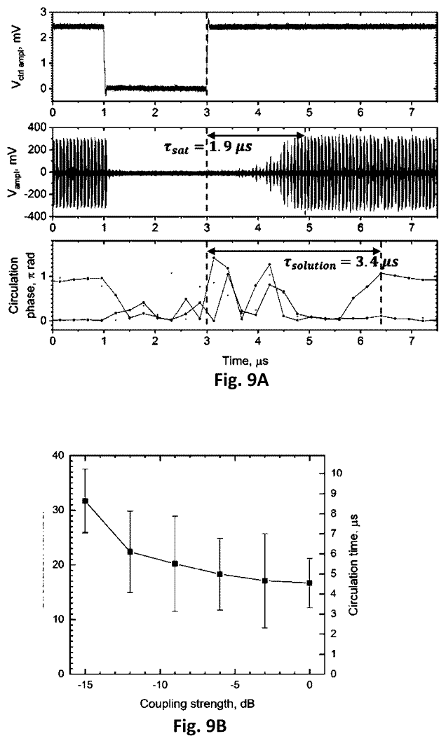

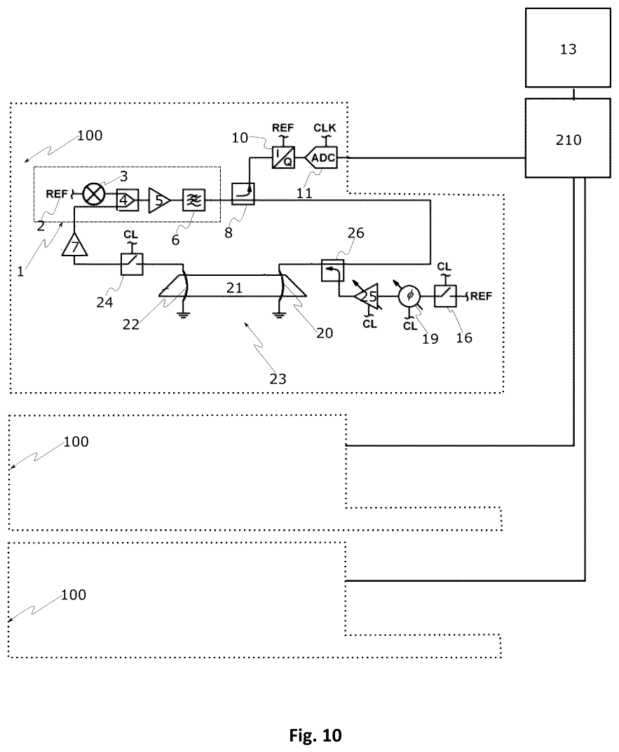

FIG. 9 shows a SCIM comprising a plurality of ring circuits 100. Each ring circuit 100 comprises a respective spinwave delay line 21, and a phase sensitive amplifier block 1. Each ring circuit 100 is connected to a programmable module 13, 210, implemented via the FPGA 210 forming at least the annealing and computing unit 400. Due to the reduced physical and power footprint of the present ring circuit, multiple ring circuits are practically feasible in a single SCIM. Each ring circuit may comprise a respective electric linear amplifier. The plurality of ring circuits enables an increased number of spins to be performed by the SCIM.

### EXAMPLES

### 4 Spin MAX-CUT Solution

The following illustrative example demonstrates the physical mechanisms and routes for obtaining a solution to a simple 4-spin MAX-CUT problem and is representative of embodiments of the schematic design, the physical parameters, and methods described herein are not meant to be limiting.

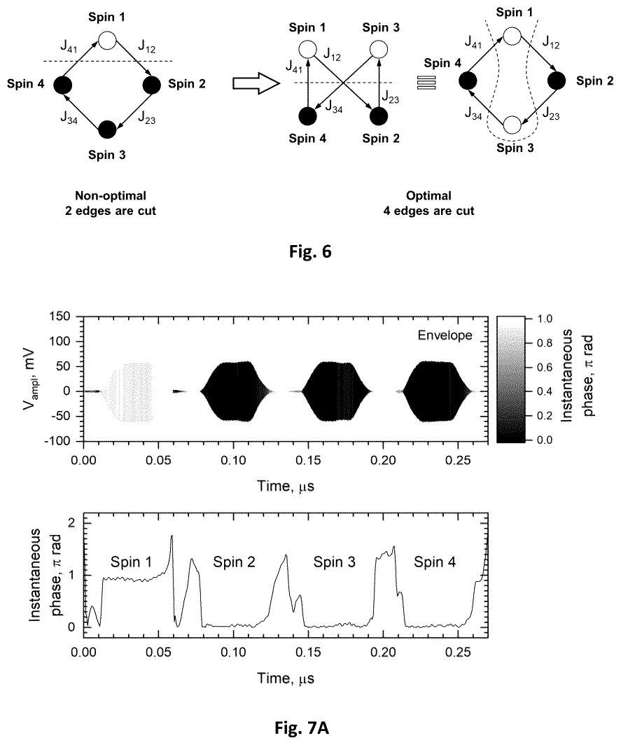

FIG. 6 shows a 4-spin MAX-CUT problem with nearest-neighbour connections which is described by the following Ising matrix:

$${J}_{ij} = \{ \begin{matrix}0 & - 1 & 0 & 0 \\ 0 & 0 & - 1 & 0 \\ 0 & 0 & 0 & - 1 \\ - 1 & 0 & 0 & 0\end{matrix} \} \qquad ( 7 )$$

The initial state of the system is chosen randomly to be cⱼ={+1 −1 −1 −13. Value +1 corresponds to 180° of the phase difference between the RF pulse and the reference signal 2, while value −1 corresponds to 0° of phase difference.

$$fsw = N / τ delay \qquad ( 8 )$$

The problem (7) is mapped into the SCIM using a single cable delay line 17 with a delay time that according to (6) equals to a pulse repetition period of 68 ns according to equation 8. Each microwave RF pulse that passes through the coupler 8 generates both a spinwave RF pulse in the 5 μm thick YIG delay line 21 and a coupling microwave RF pulse propagating through the cable delay line 17. After 68 ns the coupling microwave RF pulse reaches the coupler 26 and combines with a different microwave RF microwave pulse converted from a propagating spinwave RF pulse, effectively implementing the coupling between these two spins. The negative sign of the coupling coefficients Jᵢⱼ is realised using an additional 180° of phase shift implemented with the variable phase shifter 19. The RF switch 16 is always open so that each RF pulse cᵢ is directionally coupled to an RF pulse cᵢ₊₁ via a single cable delay. In initial state, additional coupling RF pulses have the following values fᵢ={+1 −1 +1 +1}. Controlling components 19, 25 set the amplitude and phase of additional delayed coupling RF pulses according to table 1 below:

TABLE 1

| fᵢ | Amplitude | Phase |
|---|---|---|
| +1 | 1 | 180° |
| −1 | 1 | 0° |
| 0 | 0 | 180° or 0° |

The measurement block composed of components 8, 9, 10, 11, 13 reads the instantaneous phase at the centre of each RF pulse, rounds its value, and processes the data as an intermediate state of the Ising system.

FIG. 6 shows schematically the initial state that corresponds to the edge cut number of 2 which is a non-optimal solution for a MAX-CUT problem defined by (Eq. 7). After 12 circulations SCIM evolves to a state c_{j final}={+1 −1 +1 −1} which represents an optimal solution. The microcontroller 13 detects it as a stable state and sends c_{j final} to the data port 14.

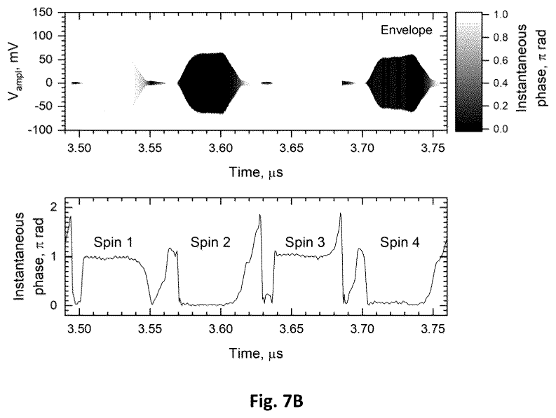

FIG. 7 shows the time traces of circulating RF pulses and computed instantaneous phase for the 1^{st} and 12^{th} circulation periods. The phase of spin 3 has changed from 0° (c₃=−1) to 180° (c₃=+1).

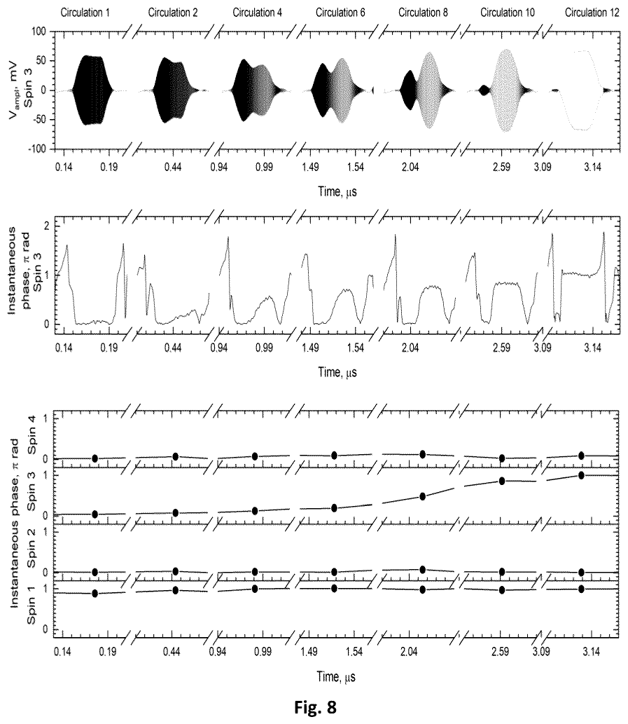

FIG. 8 shows the evolution of times traces and computed instantaneous phase for the 3^{rd} RF pulse within intermediate circulations steps. The instantaneous phase changes nonuniformly forming a temporal “domain wall” whose intermediate phase forces the formation of a dip in RF amplitude in the middle of the RF pulse which gradually propagates to the left and disappears leading to a uniformly distributed instantaneous phase of 180° (c₃=+1).

### 8 Spin MAX-CUT Solution

Similarly, the SCIM's capability to solve 8-spin MAX-CUT problems was confirmed. The frequency f_{sw} of RF switch 1 was hence increased to 29.6 MHz according to eq. 8 to increase the spin capacity to eight.

As the corresponding repetition period decreased to 34 ns, a shorter coupling delay cable with 34 ns delay was used for this experiment. As can be seen in FIG. 2(b) the spinwave RF pulses start to show some minor overlap, which could nevertheless be neglected, as the SCIM had reached the correct solution when interrogated after 12 cycles.

The above disclosure has demonstrated a spinwave time-multiplexed Ising machine (SCIM) and characterized its computational performance and functionality. It has been shown how the SCIM can solve 4- and 8-spin NP-hard MAX-CUT problems in about 3.5 μs, which is comparable to existing faster than optical CIMs. The multiphysics design allows the use of power-efficient and conventional low-power microwave components consuming 2 W of power, which amounts to an energy consumption of only 7 μJ. This outperforms optical CIM by 3-5 orders of magnitude. The vast variety of nonlinear spinwave modes and phenomena, and the direct availability of more optimized microwave signal processing components, enables scaling potential of the SCIM in terms of number of supported Ising spins, device size, and power consumption, making SCIM a commercially feasible platform for solving a wide range of optimization problems.

Although, the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc. do not preclude a plurality. Reference signs in the claims are provided merely as a clarifying example and shall not be construed as limiting the scope of the claims in any way.

List of references used in the figures:

| Reference Numbers | |
|---|---|
| (FIG. 2A & 2B unless | |
| otherwise indicated) | Element |
| 1 | Phase sensitive amplifier block |
| 2 | Reference signal |
| 3 | Frequency doubler |
| 4 | Power divider 1:1 |
| 5 | RF amplifier |
| 6 | Highpass filter |
| 7 | RF Amplifier |
| 8 | RF coupler 1:10 |
| 9 (FIG. | Power divider 1:1 |
| 2A only) | |
| 10 | I and Q demodulator |
| 11 | Analog to Digital Converter |
| 12 | Control line to microcontroller |
| 13 | Microcontroller |
| 14 | Data line |
| 15 (FIG. | Multichannel RF splitter |
| 2A only) | |
| 210 (FIG. | Field-Programmable Gate Array |
| 2B only) | |
| 16 | RF switch |
| 17 (FIG. | Cable delay line |
| 2A only) | |
| 18 (FIG. | Multichannel RF combiner |
| 2A only) | |
| 19 | Digital phase shifter |
| 20 | Input electromagnetic-to-spinwave transducer |
| 21 | YIG spinwave waveguide |
| 22 | Output spinwave-to-electromagnetic |
| | transducer |
| 23 | Spinwave delay line |
| 24 | RF switch |
| 25 | Digital variable amplifier/attenuator |
| 26 | RF coupler 1:10 |
| 100 | Ring circuit |
| 200 | Measuring unit |
| 300 | Interaction unit |
| 400 | Annealing and computing unit |

1-14. (canceled)

15. A spinwave Coherent Ising computational machine, SCIM, comprising:
a ring circuit, the ring circuit comprising:
a spinwave delay line for propagating a plurality artificial Ising spinwave RF pulses, the spinwave delay line comprising input and output spinwave-microwave transducers for transforming electromagnetic microwave RF pulses to and from spinwave RF pulses respectively in the spinwave delay line,
an electronic parametric phase-sensitive amplifier electrically connected to the spinwave delay line, the parametric phase-sensitive amplifier configured to cause phase degeneracy of the plurality of propagating artificial Ising spinwave RF pulses, and set an oscillation frequency corresponding to half a reference frequency, the reference frequency being provided by a reference signal;
wherein the SCIM further comprises:
a measuring unit in connection with the ring circuit, the measuring unit configured to measure the phase of each of the plurality of artificial Ising spinwave RF pulses each time the plurality of pseudo spin pulses circularly propagates in the ring circuit;
an interaction unit in connection with the ring circuit, the interaction unit for implementing the magnitude and phase of the interactions corresponding to the artificial spinwave RF pulses; and,
an annealing and computing unit in connection with the ring circuit, the annealing and computing unit configured to perform annealing of the plurality of artificial Ising spinwave RF pulses and perform statistical analysis on the plurality of steady-state solutions of the Ising machine.

16. The SCIM according to claim 15, wherein the spinwave delay line comprises a ferromagnetic wave propagating material in which the spin pulses propagate at a speed substantially less than the speed of light.

17. The SCIM according to claim 15, wherein the measurement unit receives a portion of the RF signal power propagating in the ring circuit via a directional RF coupler.

18. The SCIM according to claim 15, wherein the measuring unit comprises a directional RF coupler, an IQ-demodulator, and a programmable module for implementing the CORDIC algorithm.

19. The SCIM according to claim 15, wherein the interaction unit comprises at least one cable delay line or a programmable module.

20. The SCIM according to claim 19, wherein the interaction unit comprises at least one cable delay line, and additionally, an RF switch provided to each at least one cable delay line, and a digital phase shifter for realising a negative spin coupling coefficient.

21. The SCIM according to claim 19, wherein the interaction unit comprises a programmable module wherein the programmable module comprises a microcontroller and a field programmable gate array, FPGA, wherein the interaction unit additionally comprises a digital phase shifter, a digital attenuator, and an RF coupler for connecting an output of the interaction unit to the ring circuit.

22. The SCIM according to claim 15, comprising an electric linear amplifier configured to compensate the amplitude losses of the plurality of propagating spinwave pulses.

23. The SCIM according to claim 15, wherein the plurality of artificial Ising spinwave RF pulses are in the form of parametric oscillator and wherein the parametric oscillators are time-multiplexed in a single spinwave delay line.

24. The SCIM according to claim 15, wherein the SCIM comprises a plurality of ring circuits, each ring circuit comprising a respective spinwave delay line and phase-sensitive amplifier.

25. An Ising model computation method comprising:
receiving in a ring circuit a microwave RF pulse, the ring circuit comprising a spinwave delay line and a phase-sensitive amplifier;
transforming the electromagnetic microwave RF pulse to a spinwave RF pulse in the spinwave delay line via an input transducer;
transforming the spinwave RF pulse from the spinwave delay line to an artificial Ising spinwave RF pulse via an output transducer;
phase degenerating the microwave RF pulse and setting an oscillation frequency corresponding to half a reference frequency provided by a reference signal via the phase-sensitive amplifier;
receiving the artificial spinwave RF pulse at an interaction unit connected to the ring circuit and, implementing the magnitude and phase of the interactions corresponding to the artificial spinwave RF pulses via the interaction unit;
measuring the phase of the artificial Ising spinwave RF pulse as the pulse propagates in the ring circuit via a measuring unit connected to the ring circuit; and,
annealing the artificial Ising spinwave RF pulse and performing statistical analysis on the steady-state solutions of the Ising machine via an annealing and computing unit connected to the ring circuit.

26. The method according to claim 25, wherein the measuring unit receives each propagated artificial spinwave RF pulse after the measuring unit completes one set of measurement and before the measuring unit restarts another set of measurement.

27. The method according to claim 25, wherein the method comprises receiving a plurality of microwave RF pulses in the ring circuit.

28. The method according to claim 27, wherein the method comprises delaying the propagation of an artificial Ising spinwave RF pulse in the interaction unit for a duration of exactly one period of pulse repetition time in the ring circuit.
